(19) United States
(12) Patent Application Publication
(10) Pub. No.: US 2009/0308476 A1
(43) Pub. Date: Dec. 17, 2009

(54) Pipe measurement

(76) Inventors: Damian DeMartino, Tampa, FL (US); Alexandra Wolfe, Tampa, FL (US)

Correspondence Address: Alexandra Wolfe, 4421 W. Gray Street, Tampa, FL, 33609, US

(21) Appl. No.: 12/157,953

(22) Filed: Jun. 16, 2008

(51) Int. Cl. F16L 55/00

(52) U.S. Cl. 138/104; 138/178

(57) ABSTRACT

An improvement to polyvinyl chloride (PVC) piping that involves printing or otherwise adding markings to the outside of piping to allow for an efficient method of measurement. An improvement to polyvinyl chloride (PVC) piping that involves printing markers for inches and feet along either one or both sides of the pipe to indicate its length. If only one side is used, the inches and feet would increase in number. If both sides are used, the numbers would increase on one side of piping and decrease on the other side.

### FIELD OF THE INVENTION

The present method for measuring polyvinyl chloride (PVC) is to use a tape measure and manually holding it along the PVC piping to measure the length.

### BACKGROUND

Currently, measuring the length of polyvinyl chloride (PVC) piping needed is obtained by holding a tape measure along the length of pipe and marking the inches and/or feet required. This current method is time consuming, inconvenient and cumbersome. In order to cut the correct amount of pipe required to be laid quickly and accurately, the printed tape measure on the pipe could be read and the cut made where necessary.

### SUMMARY

The present method for measuring pipe is done by manually placing a tape measure along a circular pipe and marking the amount of pipe needed and where to cut.

An advantage of the improvement is the ability to easily see how long the pipe is and being able to cut the correct amount of pipe required to be placed without having to get out a tape measure, hold down one end, and mark out the amount of pipe required and needing to be cut.

### BRIEF DESCRIPTION OF THE DRAWINGS

In the accompanying drawings, which illustrate an exemplary embodiment of the present improvement:

FIG. 1 is a piece of polyvinyl chloride (PVC) pipe with six feet printed along the pipe in ascending order. The exploded view shows an example of the inches that would also be printed on the pipe. The example only includes six inches but the pipe would include markers for inches and feet.

FIG. 2 is a piece of polyvinyl chloride (PVC) pipe with six feet printed along the pipe in descending order to show the pipe if both sides were used. The reverse side of the pipe would also include markers for inches and feet.

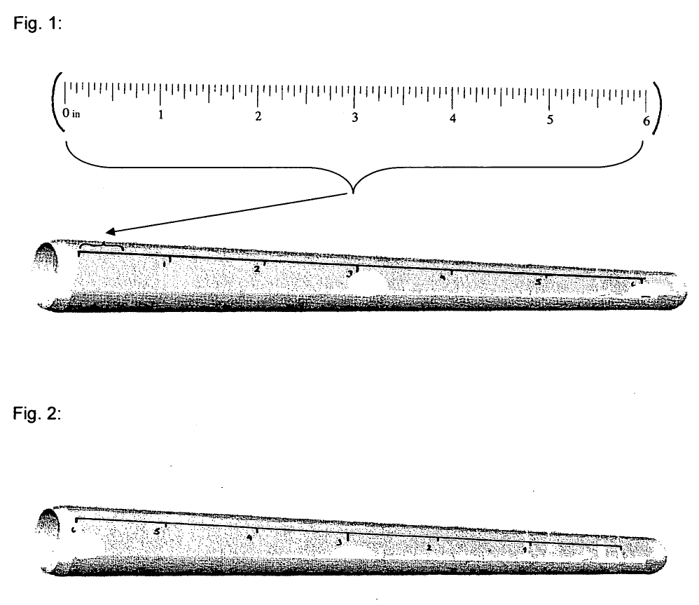

What is claimed is:

1. Pipe with dimensions printed or otherwise marked along its length at one or more locations about the circumference.

2. Pipe of claim one where dimensions are either marked using linear and/or numerical markings to identify measurements.

3. Pipe of claim 1 or 2 where if more than one set of dimensions is printed, one or more are ascending and/or one or more are descending in value.

4. Pipe of claim 1 or 2 or 3 where dimensions are inches and/or feet or other imperial dimensions.

5. Pipe of claim 1 or 2 or 3 where dimensions are millimeters and/or meters or other metric dimensions.
